(19) United States
(12) Patent Application Publication
(10) Pub. No.: US 2013/0085997 A1
(43) Pub. Date: Apr. 4, 2013

(54) INFORMATION SEARCH SYSTEM, SEARCH SERVER AND PROGRAM

(71) Applicants: Yasuhiro KIRIHATA, Tokyo (JP); Koji NAKAYAMA, Tokyo (JP); Shimpei NISHIDA, Tokyo (JP)

(72) Inventors: Yasuhiro KIRIHATA, Tokyo (JP); Koji NAKAYAMA, Tokyo (JP); Shimpei NISHIDA, Tokyo (JP)

(73) Assignee: HITACHI SOLUTIONS, LTD., Tokyo (JP)

(21) Appl. No.: 13/410,826

(22) Filed: Mar. 2, 2012

(30) Foreign Application Priority Data
Sep. 29, 2011 (JP) 2011-214003

(51) Int. Cl. G06F 12/16; G06F 17/30

(52) U.S. Cl. 707/649; 707/E17.005

(57) ABSTRACT

In order for a conventional information search system to realize online updating of search indices, there would have to be provided two systems of physical storages for storing copies of indices, namely one for searching and another for updating. By means of a snapshot function provided by an OS, duplicates of original indices are created. A search engine is attached to those duplicates and is used as such, while an index update process is applied to the original index data.

### BACKGROUND

1. Technical Field

The present invention relates to an information search system and search server capable of suppressing an increase in index volume.

2. Background Art

With the arrival of the information explosion era, the amount of data handled within organizations and enterprises is increasing exponentially. It is noted that the majority of the data showing marked increases is said to be unstructured data, such as files, etc. Given the increase in the amount of data, improvements in operational efficiency through information management/reuse are being demanded. Along therewith, there is a growing need for file search technologies among organizations and enterprises. On top of this background, the introduction of enterprise searches within enterprises is being advanced through the development and promulgation of mass data processing technologies and file search technologies that have taken place in recent years.

One item that may be listed among performance requirements of search systems is the time taken to update indices (hereinafter “update processing time”). With respect to update processing time, the shorter the batch processing time of a regularly executed index update process, the better.

Another item that may be listed among performance requirements of search systems is a function of regularly updating indices without suspending the search service, in other words, the availability of the search service. With respect to updating indices without suspending the search service, there is a method in which two indices, namely, one for searching and another for updating, are used. This method provides a search service using search indices, while updating update indices in the background. Specifically, only those files that have been newly updated since the last index update are configured as differential indices, and the update indices are merged. However, for this method, there physically have to be two holding areas for index data, which causes the storage volume to be twice the minimum requisite amount.

By way of example, in JP Patent Application Publication (Kokai) No. 2001-14342 A (Patent Document 1), the following method is disclosed as a scheme for compressing/reducing index data. External document numbers and internal document numbers are managed through a table. When a document is updated, only the location information regarding the text string whose location has been altered through editing is added to the index. A high-speed index updating function is thus realized, while at the same time preventing duplicate registration of location information. An increase in total index volume is consequently suppressed.

On the other hand, the following method is disclosed in JP Patent Application Publication (Kokai) No. 2010-262379 A (Patent Document 2). At the time of index generation, the text string of each document is divided word by word, and location information indicating where each word is located counting from the beginning is identified in terms of a number. The numbers indicating the locations of the respective words are then aggregated to numerical values of or below a pre-defined fixed length. Finally, a sequence of location information is mapped to a single transposition list and stored. The index size is thus reduced. Further, by aggregating location information using an arbitrarily specified delimiter instead of a fixed length, detection omissions are prevented albeit at the risk of false detections.

### SUMMARY

With the inventions according to Patent Documents 1 and 2 discussed above, compression/reduction of the index data itself is realized by improving the data storage scheme for individual index data. However, it still remains that, in order to update indices without suspending the search service, two systems of index data are physically held, making it difficult to prevent a significant increase in data volume due to duplication. Further, they are not schemes that realize more efficient index optimization processing either.

The present invention realizes online index updating while preventing a physical increase in data volume caused by index duplication.

In order to solve the problem above, in an information search system according to the present invention, a snapshot of an original index file is created, and the snapshot data is utilized for search indices, while the original data is used for updating.

With the present invention, it is possible to reduce the physical storage capacity required, while maintaining availability during index updates. Other problems, features, and advantages will become apparent through the description provided below.

### BRIEF DESCRIPTION OF THE DRAWINGS

FIG. 1 is a diagram illustrating a configuration of an information search system according to an embodiment.

FIG. 2 is a diagram showing a concept of an index update process that uses a snapshot.

FIG. 3 is a diagram showing a configuration example of a crawling management DB table.

FIG. 4 is a flowchart illustrating an overall process regarding index generation and update.

FIG. 5 is a flowchart illustrating a crawling process.

FIG. 6 is a flowchart illustrating a differential index generation process.

FIG. 7 is a flowchart illustrating an index update process.

### DETAILED DESCRIPTION OF PREFERRED EMBODIMENTS

With respect to the embodiments below, where necessary for purposes of convenience, descriptions are provided by being divided into a plurality of sections or embodiments. With respect to the embodiments below, when reference is made to the quantity of a given element (including numbers, numerical values, amounts, ranges, etc.), unless it is explicitly stated otherwise or a particular quantity is obviously required theoretically, and so forth, that particular quantity is by no means limiting, and there may be more, or fewer, elements than that particular quantity.

Embodiments of the present invention are described in detail below with reference to the drawings. It is noted that in all of the drawings illustrating embodiments, the same or related reference numerals are assigned to members with the same functions, while omitting repetitive descriptions thereof. Further, in the embodiments below, unless required, descriptions of the same or similar parts will generally not be repeated.

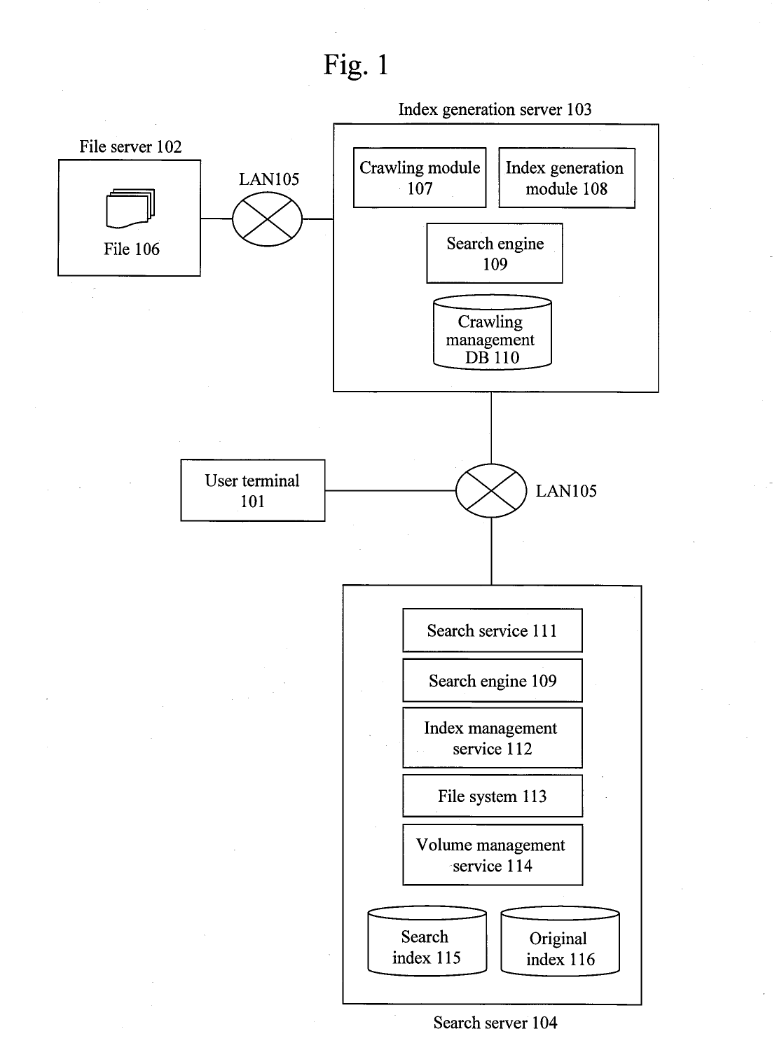

The overall configuration of an information search system according to an embodiment is shown in FIG. 1. The system comprises a user terminal 101, a file server 102, an index generation server 103, and a search server 104. In the case of the present embodiment, the file server 102 and the index generation server 103 are connected via a LAN 105. The user terminal 101, the index generation server 103 and the search server 104 are connected via the LAN 105. Although, in the present embodiment, the devices are connected via the LAN 105, they may also be connected via a network such as the Internet, etc., instead.

Although FIG. 1 shows an example where the index generation server 103 and the search server 104 are run on physically distinct machines, these servers may also be run on physically the same machine instead.

Files 106 subject to searches are stored on the file server 102. A crawling module 107, an index generation module 108, a search engine 109, and a crawling management DB 110 are disposed in the index generation server 103. The crawling module 107 provides a function of searching in the file server 102 to find and download an update file. The index generation module 108 generates a differential index from downloaded data. The search engine 109 is a module that provides an index generation/search function, and there are open source search engines such as Apache Lucene and Senna. The search engine 109 is used by the index generation module 108 at the time of differential index generation. The crawling management DB 110 manages file/directory updates that have been made since crawling was last performed.

The search engine 109, a search service 111, an index management service 112, a file system 113, a volume management service 114, a search index 115, and an original index 116 are disposed in the search server 104. As the search service 111 receives a search request from the user terminal 101, it responds by generating a search result using the search engine 109. The index management service 112 performs an update process with respect to the original index 116 based on the differential index and delete file list generated at the index generation server 103. In addition, after the original index 116 is updated, the index management service 112 generates the search index 115 through a snapshot function that the volume management service 114 provides. Further, the index management service 112 provides an attach function of a search core provided by the search engine 109 which makes the generated search index 115 searchable. By way of example, with respect to Solr, which realizes an Apache Lucene-based search service, there are SokCores, which corresponds to the search core mentioned above, and by dynamically switching SokCores to which indices are attached, a function of switching searchable indices in real time is realized. The volume management service 114 is a service that the OS of the search server is equipped with and makes it possible to configure a logical volume. Linux's LVM (Logical Volume Manager) is one such example. The volume management service 114 provides a function of creating a snapshot with respect to a configured volume. The snapshot function is a function that generates a copy of a volume instantaneously by Copy On Write, and the generated copy is accessible by Read Only.

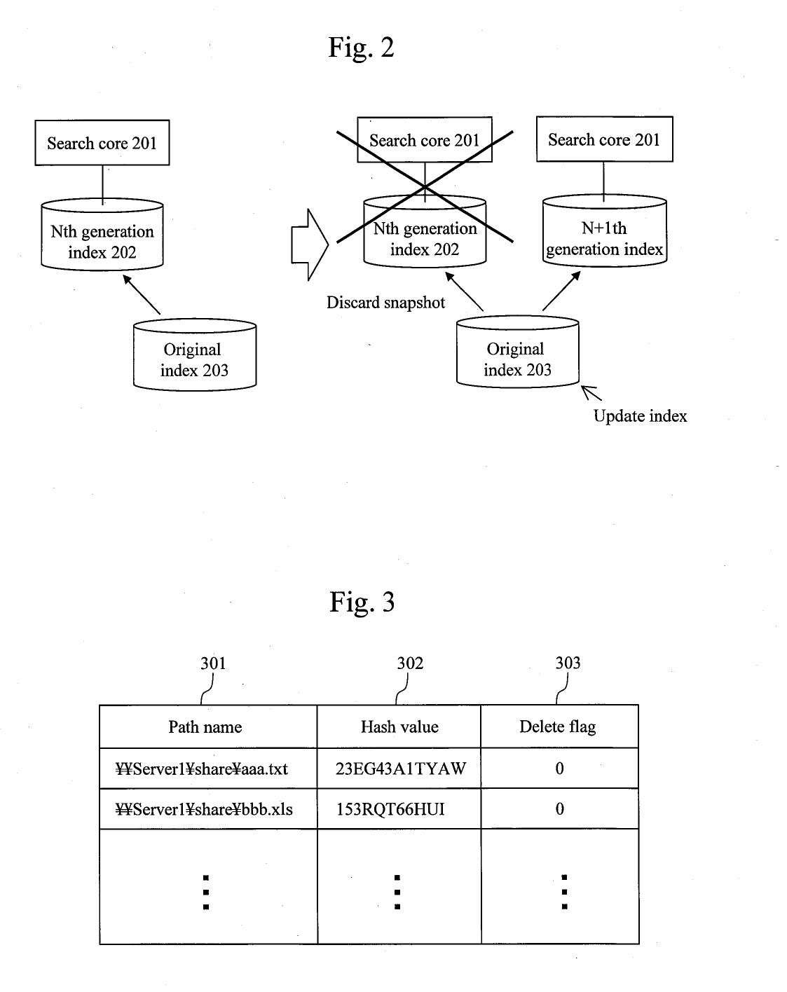

The concept of an index update process that uses a snapshot is shown in FIG. 2. As a search index, an Nth (where N is a natural number) generation index 202 to which a search core 201 is attached is an index in a volume that is generated and copied by a snapshot with respect to a logical volume in which an original index 203 is stored. In response to a search request, the search engine 109 accesses the Nth generation index 202, which is the search index 115, and executes a search process. In the search process, access to the index is Read Only. Thus, it is possible to perform a search process with respect to index data of a snapshot by attaching the search core 201.

At the time of the next update, an update process is performed with respect to the original index 203. In so doing, it is possible to update the data of the original index 203 while leaving the data of the Nth generation index 202 of the snapshot intact. Once updated, a new snapshot is generated, and index data of that snapshot is taken to be the N+1th generation index. Once the search core 201 is attached to this N+1th generation index to make it searchable, the snapshot that stores the Nth generation index is deleted. By thus utilizing snapshots, it is possible to compress/reduce the storage capacity taken up by indices as compared to schemes in which indices are physically and entirely duplicated.

A structure example of a table registered in the crawling management DB 110 is shown in FIG. 3. Attribute values of the table comprise a path name 301, a hash value 302, and a delete flag 303. The path name 301 records file paths of files/directories stored within a file server subject to searches. The hash value 302 stores hash values of attribute information (file path, date and time of update, owner, ACL, etc.) of files/directories. The hash value 302 is used for the detection of updates in files specified by the respective file paths.

The delete flag 303 is flag information to be used to check whether or not a file/directory corresponding to a registered entry has been deleted since crawling was last performed. The delete flag 303 is set to “1” as an initial value upon crawling, and to “0” for files/directories whose presence has been confirmed through crawling. By looking for entries whose delete flags 303 are “1” upon completion of crawling for all files/directories, it is possible to create a delete file list.

The index generation server 103 generates a delete file list and differential indices for files that have been newly created/updated, and forwards them to the search server 104. Using the forwarded delete file list and differential indices, the search server 104 executes an update process for the indices currently in use.

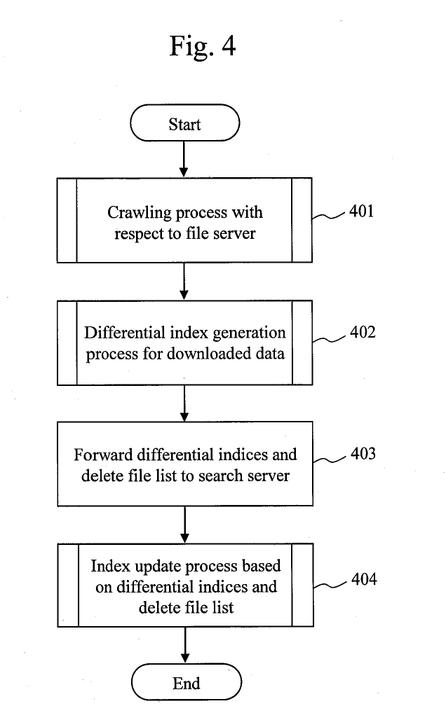

A flowchart illustrating an index generation/update process is shown in FIG. 4. The index generation/update process is a process executed regularly on the index generation server 103 and the search server 104. The index generation/update process is a process that updates the indices currently in use on the search server 104 with respect to files/directories that have been newly created/updated or deleted since the process was last executed.

As the index generation/update process is started, the index generation server 103 executes a crawling process with respect to the file server 102 that is subject to searches (step 401). In the crawling process, a list of files that have been deleted since the last index generation/update process (i.e., delete file list) is created, and files that have been newly created/updated are downloaded. A differential index generation process using the downloaded file data is thereafter performed (step 402). Next, the generated differential indices and delete file list are forwarded to the search server 104 (step 403), and a process of updating the indices currently used for searches is executed on the search server 104 based on the forwarded data (step 404). Details of the crawling process, differential index generation process, and index update process, which have been defined as subroutines in the flowchart, will be described through subsequent flowcharts.

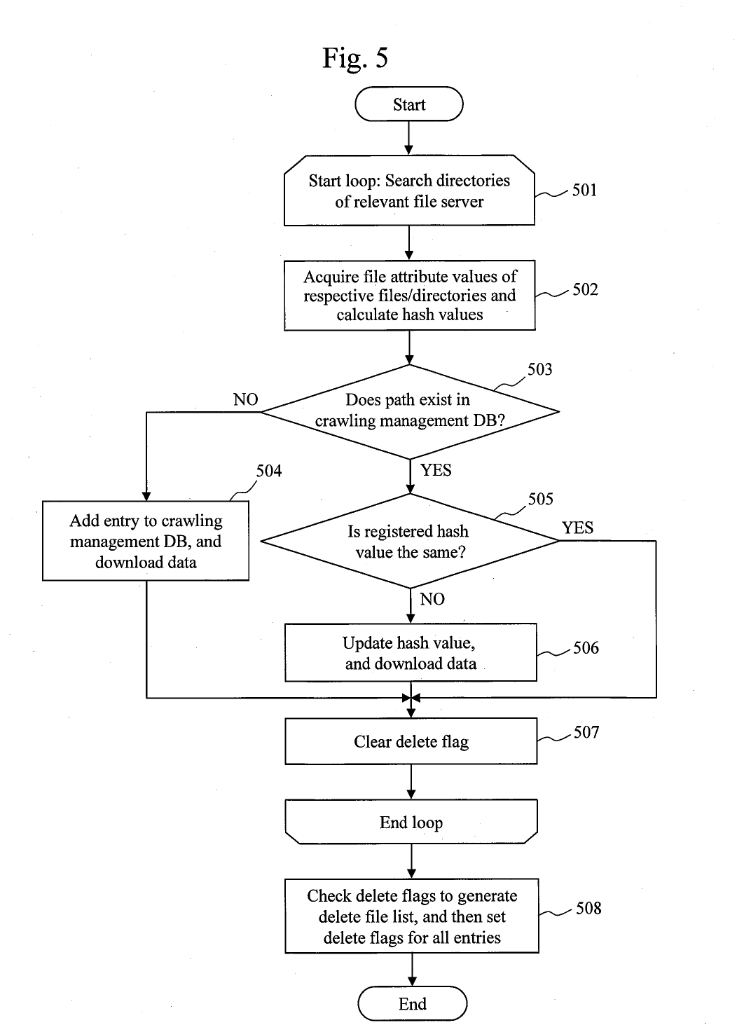

A flowchart for the crawling process is shown in FIG. 5. The crawling process is executed at the crawling module 107 within the index generation server. The crawling module 107 searches directories of the file server 102 that is subject to searches, but performs a loop process with respect to each file/directory searched for (step 501).

First, the crawling module 107 acquires file attribute values of files/directories that are to be searched for, and calculates hash values (step 502). Next, with file paths as keys, it checks the crawling management DB 110 to see whether or not entries for the specified file paths exist within the DB (step 503).

If a given file path does not exist in the crawling management DB 110 (i.e., in the case of a negative result in step 503), this would signify that the file/directory for that file path was newly generated after the last time crawling was performed. As such, the crawling module 107 adds an entry to the crawling management DB 110, and if it is a file, downloads data (step 504). Since the file/directory exists, the crawling module 107 clears the delete flag (step 507), and proceeds to the next search file/directory process in the loop.

On the other hand, if a given file path does exist in the crawling management DB 110 (i.e., in the case of an affirmative result in step 503), the crawling module 107 checks whether or not the calculated hash value of the file attribute value is equal to the hash value registered in the crawling management DB 110 (step 505).

If the calculated hash value is the same as the registered hash value (i.e., in the case of an affirmative result in step 505), this would signify that it has not been updated since the last time crawling was performed. In this case, the crawling module 107 does not perform a data download process, clears the delete flag, and proceeds to the next step in the loop process (step 507).

If the calculated hash value differs from the registered hash value (i.e., in the case of a negative result in step 505), this would signify that the file/directory has been updated since the last time crawling was performed. In this case, the crawling module 107 updates the hash value of the entry, and if it is a file, downloads data (step 506). The crawling module 107 thereafter clears the delete flag, and proceeds to the next step in the loop process (step 507).

Once the search/download process loop is completed, the crawling module 107 checks the delete flags in the crawling management DB 110, and generates a delete file list by acquiring all the file paths of the entries whose delete flags are “1.” It then initializes the delete flags of all entries to “1” for the next crawling process (step 508).

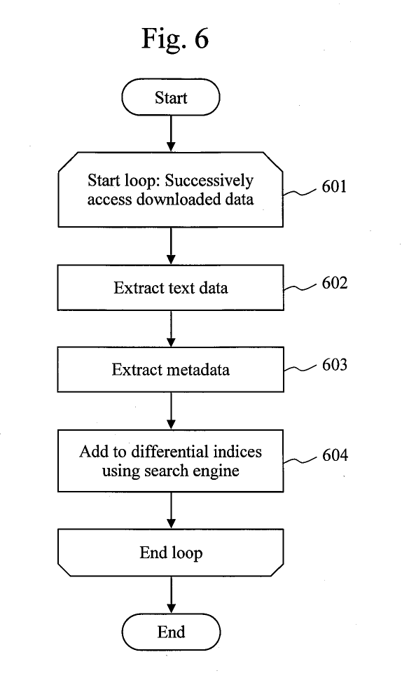

A flowchart for the differential index generation process is shown in FIG. 6. The differential index generation process is executed by the index generation module 108. This module successively accesses newly created/updated file groups downloaded through the crawling process, and executes, with respect to differential indices, a loop process for performing a registration process (step 601).

As the loop process is started, the index generation module 108 extracts text data from a file (step 602), and extracts the metadata of the file (step 603). The index generation module 108 then creates data to be additionally registered among the differential indices. Using the search engine 109 with that data as an input value, the index generation module 108 additionally registers the created data among the differential indices (step 604). The loop process is continued until all downloaded data is registered among the differential indices. The differential indices generated in this process are indices related to file groups that have been newly created/updated since the previous index generation/update process.

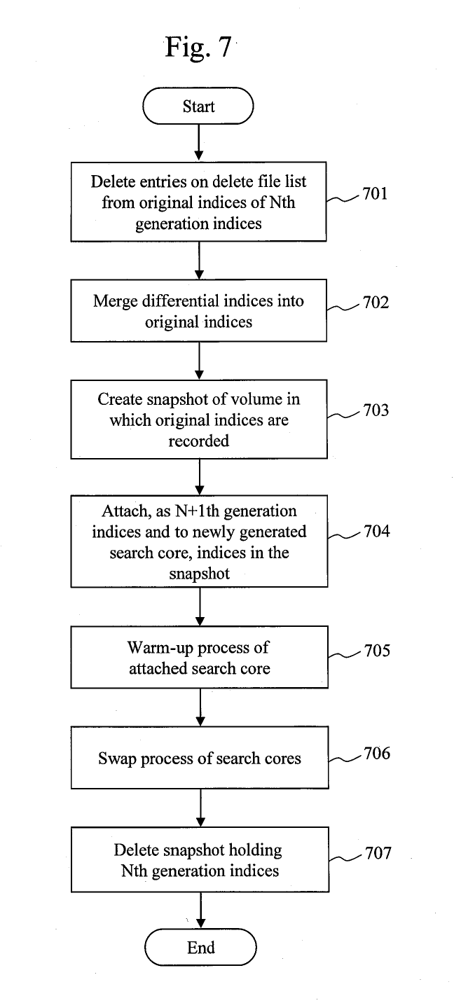

A flowchart for the index update process is shown in FIG. 7. This process is a process that is executed on the search server 104 by the index management service. It is a process that updates Nth generation indices, which are Nth generation search indices, based on the differential indices and delete file list generated at the index generation server 103.

First, with respect to the original indices from which a snapshot of the Nth generation indices is to originate, the index management service deletes entries related to the files recorded in the delete file list (step 701).

The index management service next merges the differential indices into the original indices (step 702). By way of example, in the case of Lucene, in order to merge differential indices into original indices, the index management service first deletes, from the file group registered among the differential indices, those that are registered among the original indices. The index management service then adds the data of the differential indices to the original indices.

The index management service next creates a snapshot of the volume in which the updated original indices are recorded (step 703). The index management service then attaches, as N+1th generation indices and to the newly generated search core 201, the indices in the snapshot that has been created (step 704), and executes a warm-up process of the attached search core 201 (step 705). The term warm-up process refers to a process in which, using search history information, the search core attached to the N+1th generation indices issues a query with respect to internally attached indices, and caches the results, and is carried out in order to improve the response performance of the next query. Once the warm-up process is completed, the index management service swaps the search cores 201 to which the Nth generation indices and the N+1th generation indices are respectively attached (step 706).

Through this swap process, the N+1th generation indices become searchable. Finally, the index management service discards the search core 201 attached to the Nth generation indices, and deletes the snapshot holding the Nth generation indices (step 707).

By adopting the functional configuration above, it is possible to dynamically update indices while keeping the search service running. In so doing, the updating of indices is carried out by updating a snapshot. Accordingly, an information search system according to the present embodiment does not require two sets of index data, namely one for searching and another for updating, to be held physically. It is consequently possible to save on required storage space.

### LIST OF REFERENCE NUMERALS

101: User terminal

102: File server

103: Index generation server

104: Search server

105: LAN

106: File

107: Crawling module

108: Index generation module

109: Search engine

110: Crawling management DB

111: Search service

112: Index management service

113: File system

114: Volume management service

115: Search index

116: Original index

201: Search core

202: Nth generation index

203: Original index

204: N+1th generation index

301: Path name

302: Hash value

303: Delete flag

What is claimed is:

1. An information processing system connected to a file server, the information processing system comprising:
a processing function that searches a group of files stored on the file server for a group of files that have been newly generated/updated or deleted;
a processing function that downloads a group of files that have been newly generated/updated;
a processing function that generates a delete file list regarding a group of files that have been deleted;
a processing function that generates indices for the group of files that have been downloaded;
a processing function that updates, using the indices and the delete file list, indices stored in a storage region;
a processing function that creates a snapshot of a logical volume that stores updated index data and a processing function that configures index data in the snapshotted volume as searchable indices.

2. The information processing system according to claim 1, wherein the processing function that searches the group of files stored on the file server for the group of files that have been newly generated/updated or deleted references a DB storing hash values and delete flags, senses newly generated/updated files, and recognizes deleted files, the hash values being hash values of attribute information of files/directories whose keys are respective path names of all files/directories within the file server at the time of a previous index update process.

3. The information processing system according to claim 1, further comprising a processing function that deletes a snapshot holding Nth (where N is a natural number) generation index after N+1th generation index have been configured as searchable indices.

4. A search server to be connected to an index generation server, the search server comprising:
a processing function that receives, from the index generation server, indices and a delete file list, the indices being indices of a group of files that have been newly generated/updated at a file server since the last time indices were generated, and the delete file list being a delete file list regarding a group of files that have been deleted from the file server;
a processing function that updates, using the indices and the delete file list, indices stored in a storage region;
a processing function that creates a snapshot of a logical volume that stores updated index data; and
a processing function that configures index data in the snapshotted volume as searchable indices.

5. The search server according to claim 4, further comprising a processing function that deletes a snapshot holding Nth (where N is a natural number) generation index after N+1th generation index have been configured as searchable indices.

6. A program that causes a computer, which an information processing system connected to a file server is equipped with, to execute:
a processing function that searches a group of files stored on the file server for a group of files that have been newly generated/updated or deleted;
a processing function that downloads a group of files that have been newly generated/updated;
a processing function that generates a delete file list regarding a group of files that have been deleted;
a processing function that generates indices for the group of files that have been downloaded;
a processing function that updates, using the indices and the delete file list, indices stored in a storage region;
a processing function that creates a snapshot of a logical volume that stores updated index data and a processing function that configures index data in the snapshotted volume as searchable indices.

7. The program according to claim 6, wherein the processing function that searches the group of files stored on the file server for the group of files that have been newly generated/updated or deleted references a DB storing hash values and delete flags, senses newly generated/updated files, and recognizes deleted files, the hash values being hash values of attribute information of files/directories whose keys are respective path names of all files/directories within the file server at the time of a previous index update process.

8. The program according to claim 6, further causing the computer to execute a processing function that deletes a snapshot holding Nth (where N is a natural number) generation index after N+1th generation index have been configured as searchable indices.

9. A program that causes a computer, which a search server to be connected to an index generation server is equipped with, to execute:
a processing function that receives, from the index generation server, indices and a delete file list, the indices being indices of a group of files that have been newly generated/updated at a file server since the last time indices were generated, and the delete file list being a delete file list regarding a group of files that have been deleted from the file server;
a processing function that updates, using the indices and the delete file list, indices stored in a storage region;
a processing function that creates a snapshot of a logical volume that stores updated index data and a processing function that configures index data in the snapshotted volume as searchable indices.

10. The program according to claim 9, further causing the computer to execute a processing function that deletes a snapshot holding Nth (where N is a natural number) generation index after N+1th generation index have been configured as searchable indices.
